(19) United States
(12) Patent Application Publication
(10) Pub. No.: US 2016/0042380 A1
(43) Pub. Date: Feb. 11, 2016

(54) REWARD MANAGEMENT

(71) Applicant: Zachary J. Prager, San Diego, CA (US)

(72) Inventor: Zachary J. Prager, San Diego, CA (US)

(21) Appl. No.: 14/922,716

(22) Filed: Oct. 26, 2015

Related U.S. Application Data
(63) Continuation-in-part of application No. 14/069,715, filed on Nov. 1, 2013.
(60) Provisional application No. 62/068,405, filed on Oct. 24, 2014.
(60) Provisional application No. 61/721,400, filed on Nov. 1, 2012.

(51) Int. Cl. G06Q 30/02; G06Q 50/00

(52) U.S. Cl. CPC G06Q 30/0214; G06Q 50/01

(57) ABSTRACT

For reward management, a processor receives an objective and reward from the second electronic device. The processor further receives a completion status for the objective at a first electronic device. The processor releases the reward in response to a reward policy being satisfied.

### CROSS-REFERENCE TO RELATED APPLICATIONS

This application claims priority to U.S. patent application Ser. No. 14/069,715 entitled “ACTIVITY BASED ACCESS” and filed Nov. 1, 2013 for Zachary J. Prager, which is incorporated herein by reference and claims priority to U.S. Provisional Patent Application No. 61/721,400 entitled “ACTIVITY ENABLED ACCESS” and filed on Nov. 1, 2012 for Zachary J. Prager, which is incorporated herein by reference, and the present application further claims priority to U.S. Provisional Patent Application 62/068,405 entitled “REWARD MANAGEMENT” and filed Oct. 24, 2014 for Zachary J. Prager, which is incorporated herein by reference.

### BACKGROUND

1. Field

The subject matter disclosed herein relates to reward management.

2. Description of the Related Art

Rewards are often used to motivate desired behaviors.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a reward management system;

FIG. 1B is a schematic drawing illustrating one embodiment of the beacon condition;

FIG. 2A is a schematic block diagram illustrating one embodiment of reward management data;

FIG. 2B is a schematic block diagram illustrating one embodiment of educational objective completion criteria;

FIG. 2C is a schematic block diagram illustrating one embodiment of breathing objective completion criteria;

FIG. 2D is a schematic block diagram illustrating one embodiment of movement objective completion criteria;

FIG. 2E is a schematic block diagram illustrating one embodiment of location objective completion criteria;

FIG. 2F is a schematic block diagram illustrating one embodiment of medication objective completion criteria;

FIG. 2G is a schematic block diagram illustrating one embodiment of a participant database;

FIG. 2H is a schematic block diagram illustrating one embodiment of participant data;

FIG. 3A is a drawing illustrating one embodiment of receiving an objective and reward;

FIG. 3B is a drawing illustrating one embodiment of selecting an application;

FIG. 4 is a schematic block diagram illustrating one embodiment of a computer;

FIG. 5A is a schematic flow chart diagram illustrating one embodiment of a reward management method; and

FIG. 5B is a schematic flow chart diagram illustrating one embodiment of a reward set up method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements. U.S. patent application Ser. No. 14/069,715 filed Nov. 1, 2013 is incorporated herein in its entirety.

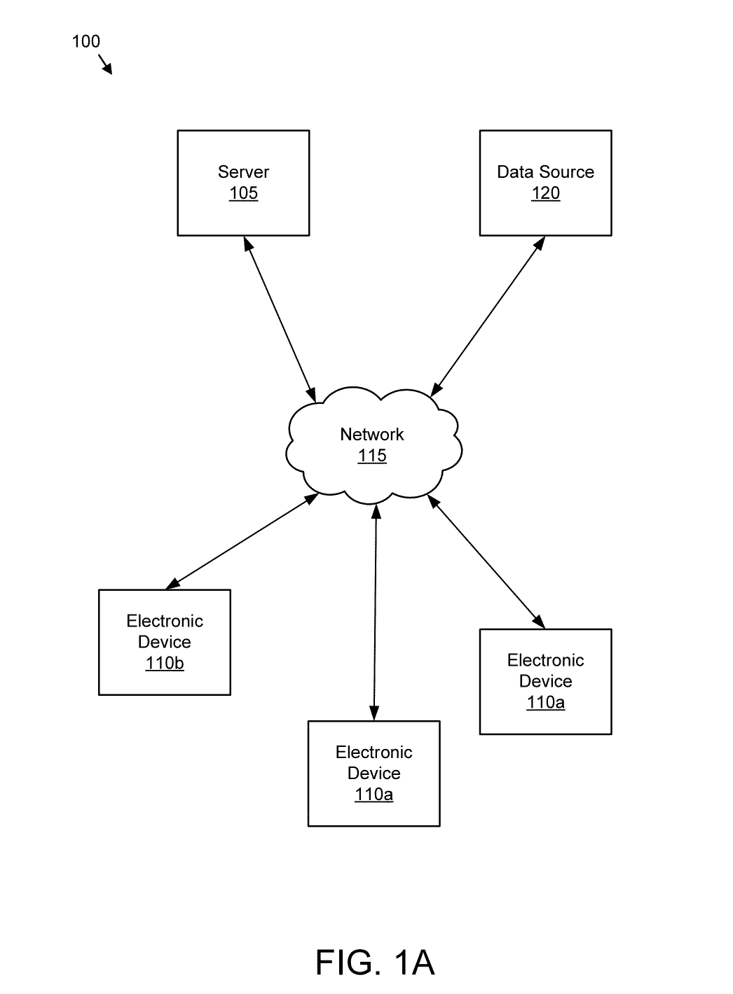

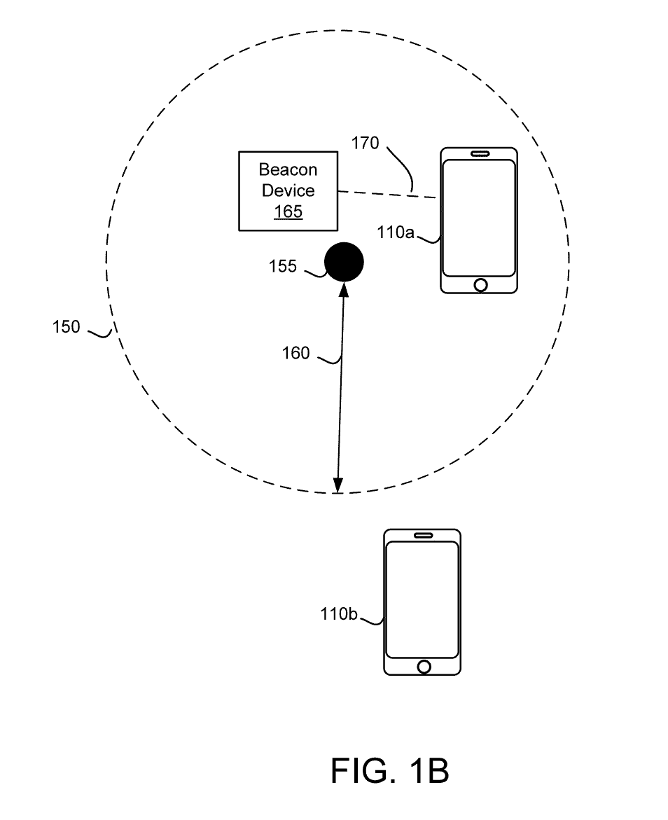

FIG. 1A is a schematic block diagram illustrating one embodiment of a reward management system 100. The system 100 may manage rewards for one or more participants. In the depicted embodiment, the system 100 includes a server 105, a network 115, and one or more electronic devices 110. A participant may interface with the system 100 through the one or more electronic devices 110.

Each electronic device 110 may communicate with other electronic devices 110 and/or the server 105 through the network 115. The network 115 may be the Internet, a mobile telephone network, a wireless network, a wide-area network, a local area network, and ad hoc network, or combinations thereof. The server 105 and/or the electronic devices 110 may also communicate with one or more data sources 120.

Rewards have long been used to motivate individuals and groups to achieve objectives. Unfortunately, the use of rewards has often been limited because of their expense and because of difficulties in managing the rewards. The embodiments described herein manage rewards for an objective for one or more participants. The embodiments may receive a completion status for the objective and may release the reward in response to a reward policy been satisfied. As a result, rewards are more easily used to achieve the objective.

Participants may set up an objective, a reward, and a reward policy through the electronic devices 110. The reward management may be coordinated by the server 105. Alternatively, the electronic devices 110 may coordinate the reward management.

The system 100 may also include the data source 120. The data source 120 may include but is not limited to financial account information, attendance information, competition information, image information, audio information, performance information, and the like. For example, a financial account data source 120 may be accessed to determine the balance of the savings account. Alternatively, a race results website data source 120 may be accessed to determine a finish time in a race.

FIG. 1B is a schematic drawing illustrating one embodiment of the beacon condition. In one embodiment, access to functionality of an electronic device 110a may be blocked when the beacon condition is satisfied. In one embodiment, the Beacon condition is a wireless connection 170 between the electronic device 110a and the beacon device 165. The wireless connection may be a BLUETOOTH® connection, a Wi-Fi connection, or the like. Alternatively, the beacon condition may comprise a beacon coordinate 155 being within a beacon distance 160 of the electronic device 110a. The beacon coordinate 155 may be a global positioning system (GPS) coordinate or the like. If electronic device 110b does not have the wireless connection 170 with the beacon device 165 or is not within the beacon distance 160 of the beacon coordinate 155, the beacon condition may not be detected.

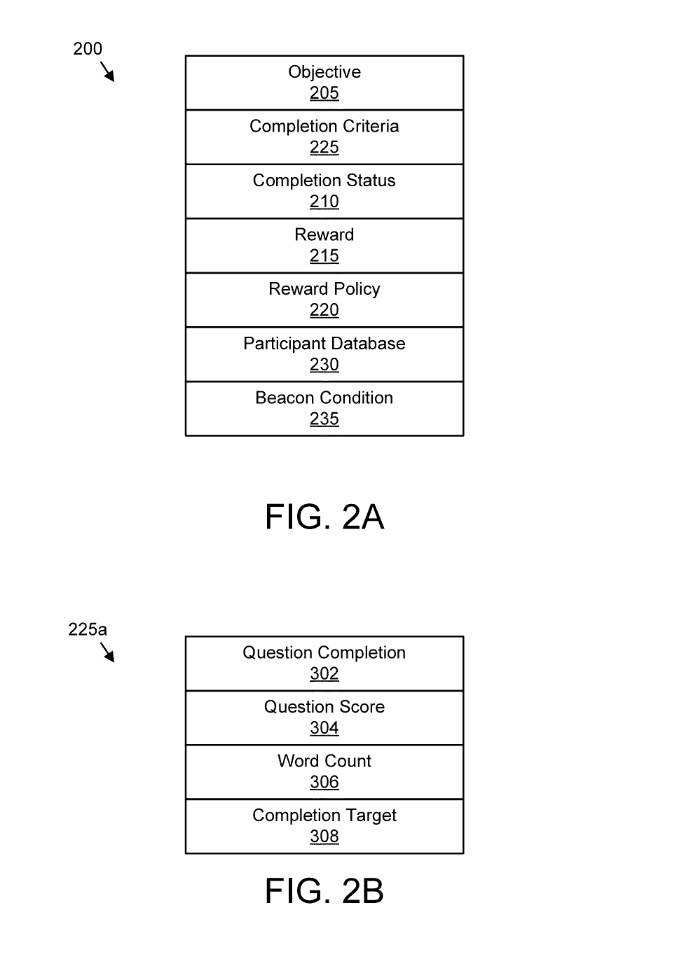

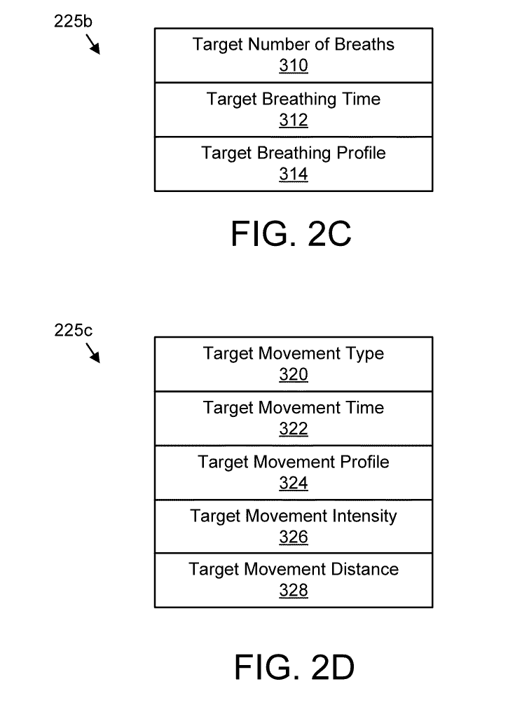

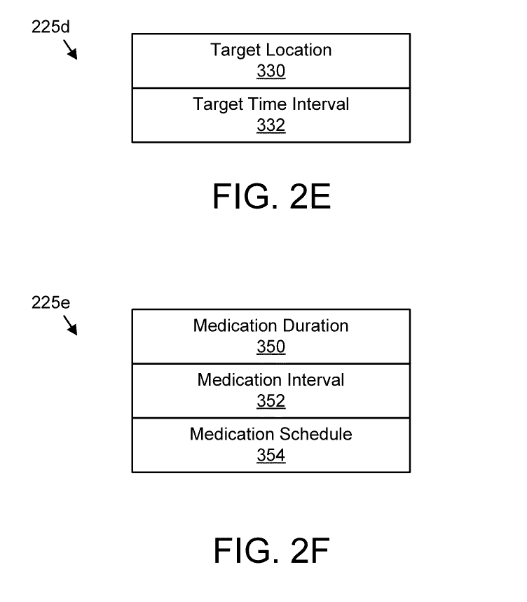

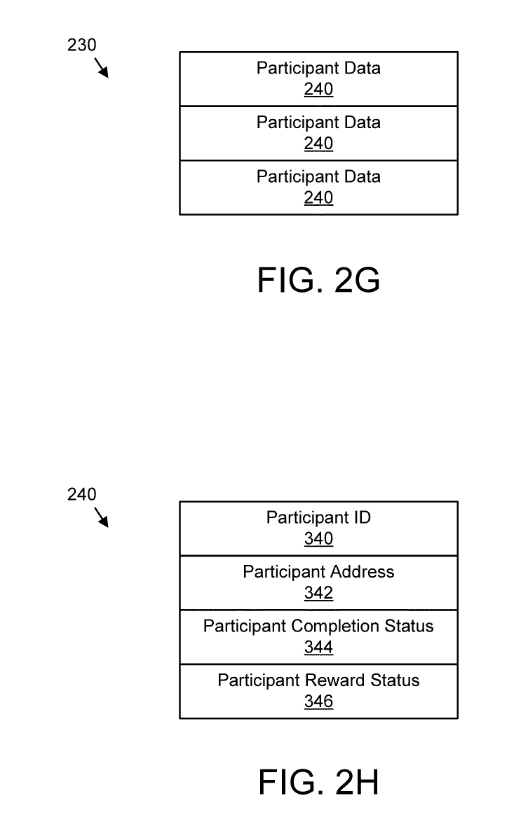

FIG. 2A is a schematic block diagram illustrating one embodiment of reward data 200. The reward data 200 may be organized as a data structure in a memory. The memory may be on the server 105, one or more electronic devices 110, or combinations thereof. The reward data 200 may be stored on the server 105, one or more electronic devices 110, or combinations thereof. In the depicted embodiment, the reward data 200 includes an objective 205, completion criteria 225, a completion status 210, a reward 215, a reward policy 220, a participant database 230, and the beacon condition 235.

In one embodiment, the reward data 200 is established by a participant using a second electronic device 110b. The second electronic device 110b may communicate the reward data 200 to one or more first electronic devices 110a as will be described hereafter.

The objective 205 may be opted in by one or more participants. The objective 205 may include a title and a description. The objective 205 may describe actions and/or conditions that must be completed to obtain the reward 215.

The completion criteria 225 may specify measurable results that indicate that the objective 205 has been completed. In one embodiment, the completion criteria 225 are autonomously measured.

Alternatively, the completion criteria 225 may be satisfied by the submission of an evidentiary image. For example, a participant may submit an evidentiary image through the electronic device 110 to validate the completion of the objective 205.

The completion criteria 225 may be satisfied by performance data. The performance data may be recorded by the electronic device 110. Alternatively, the performance data may be automatically retrieved from the data source 120. The completion criteria 225 may include but is not limited to a number of steps, a distance, and amount of money donated, a test score, an athletic victory, an addiction avoidance, and the like. For example, the completion criteria 225 may specify a maximum time for a 5 kilometer race and a participant's race time may be retrieved from a race results data source 120. In addition, the completion criteria 225 may be completion of the task such as a homework assignment.

In one embodiment, the completion criteria 225 are satisfied by communication with the designated person. The communication may be through the electronic device 110 and may be measured by the electronic device 110. Alternatively, the communication may be validated by the designated person.

In one embodiment, the completion criteria 225 may specify that a participant attest to satisfying the completion criteria 225. In addition, completion criteria 225 may specify that a third-party validate the participant attestation.

The completion criteria 225 may specify one time completion results. Alternatively, the completion criteria 225 completion results for a specified time interval, with the completion criteria 225 to be completed each specified time interval. For example, the completion criteria 225 may specify an action to be performed each week.

The completion criteria 225 may specify the use of an application. For example, the completion criteria 225 may specify the use of a stress reduction application.

The completion status 210 may record each participant's satisfaction of the completion criteria 225. The completion status 210 may be for a one-time result and/or results for one or more specified time intervals. The completion status 210 may include one or more of results autonomously recorded by the electronic device 110, results downloaded from the data source 120, results attested to by a participant, results validated by a third-party, or combinations thereof.

In one embodiment, the completion status 210 may comprise participant completion statuses from one or more participants. For example, the completion status 210 may aggregate each participant completion status. In addition, the completion status 210 may indicate if an overall reward policy 220 is satisfied. For example, if the completion criteria 225 specifies that only one participant must satisfy the completion criteria 225, than the completion status 210 indicates that the completion criteria 225 is satisfied when only one participant completion status indicates that the completion criteria 225 is satisfied.

The reward 215 may specify what is received by the participants in response to satisfying the reward policy 220. The reward 215 may be one or more of releasing a lock, releasing a lock on a first application, removing a pop-up, distributing a monetary payment, and releasing a block on a Universal Resource Locator (URL). In one embodiment, the reward 215 initially specifies a type of reward. For example, the reward may initially specify releasing a lock on an application, but without specifying the application. The application may later be selected as will be described hereafter.

The reward policy 220 may specify when the reward can be released to the one or more participants. In one embodiment, the reward policy 220 is satisfied when all participants complete the objective 205 as specified by the objective criteria 225. For example, the reward 215 may be released to all participants if all participants complete the objective 205.

The participant database 230 may list information for each participant. The participant database 230 is described hereafter in FIG. 2G. The beacon condition 235 may specify the beacon condition 235 is described in FIG. 1B.

In one example, the objective 205 may be a proximity objective. The completion criteria 225 may be satisfied by the electronic device 110 being within a completion distance of a target location. The target location may be a gym and the completion criteria 225 may be satisfied when the electronic device 110 and the accompanying participant are within a completion distance of the gym three times in a week. Alternatively, the completion criteria 225 may specify at least two participants. The reward policy 220 is satisfied in response to the at least two participants being in mutual proximity.

In one embodiment, the completion criteria 225 may specify that at least two participants be in mutual proximity. In one embodiment, the completion criteria 225 are satisfied if the at least two participants are within a proximity distance during a proximity time interval. The proximity distance may be measured by the electronic devices 110 using visual recognition, a distance from one or more wireless network bases, GPS coordinates, or the like. The reward policy 220 may be satisfied in response to the at least two participants being in mutual proximity.

In one embodiment, the objective 205 is a communication objective. The completion criteria 225 may specify at least two participants that must communicate. The reward policy 220 may be satisfied in response to the at least two participants communicating.

The objective 205 may be a competition objective. The completion criteria 225 may specify criteria for winning. And at least one participant is designated a winner and at least one participant is designated a loser. The winner may satisfy the reward policy 220.

In one example of a reward 215, an application of the electronic device 110 such as a music player or social media site may be locked. The lock may be immediately activated. Alternatively, the lock may be activated after a specified date. The lock may be set on the application of an electronic device 110 of a first participant. The application may be selected by a second participant in response to the second participant selecting the application from an application list for a first participant. The application list may list all applications on the electronic device 110 of the first participant. Alternatively, the application list may include all noncritical applications on the electronic device 110 of the first participant.

A lock may be set that prevents access to the functionality. For example, the lock may prevent virtual access to the game application. In one embodiment, the lock is set by logging out of an application. The lock may be restored by logging into the application. A password manager may be used to log in to the application.

Alternatively, the rewards 215 may remove a pop-up from the electronic device 110. The pop-up may be a reminder. In one embodiment, the reward 215 releases a physical lock. Alternatively, the reward 215 may provide a code for releasing a lock. In one embodiment, the reward 215 is a monetary payment.

In one embodiment, the objective 205 is a combined objective for two or more participants. The reward policy 220 may be satisfied if one or more participants complete the combined objective. The reward 215 may be released to all participants if the reward policy 220 is satisfied. Alternatively, the reward 215 may be released to the at least one participant who completes the combined objective 205.

In one embodiment, the reward policy 220 is satisfied if at least one participant completes the objective 205. The reward 215 may be released to all participants if the at least one participant completes the objective 205. Alternatively, the reward 215 may be released only to each participant that completes the objective 205.

In one embodiment, the reward policy 220 may be satisfied for the first participant completes the objective 205. The reward 215 may be released to the first participant in response to the first participant completing the objective 205.

In one embodiment, the objective 205 includes a location objective with completion criteria 225 of checking in at the target location. The reward policy 220 may be satisfied when all participants check in at the location objective. The participants may check-in using one or more of a wireless communication position and a global positioning system (GPS) coordinate. In one embodiment, the reward policy 220 may be satisfied for a first participant in response to the first participant checking in at the location objective.

A participant may satisfy the completion criteria 225 by being at the target location. Alternatively, the completion criteria 225 may be satisfied by being at the target location during the target time interval. The reward policy 220 may be satisfied for a first participant in response to the first participant checking in at a target location. Alternatively, the reward policy 220 may be satisfied when each participant checks in at the target location.

In one embodiment, the completion criteria 225 include a plurality of target locations. In addition, the objective 205 may include a chronological order for the plurality of target locations. The reward policy 220 may be satisfied when the participants check-in chronologically at the plurality of location objectives.

In one embodiment, the objective 205 is completing a course of electronic medication. For example, the electronic medication may be the use of a stress reduction application. The completion criteria 225 for the electronic medication objective 205 may include a medication duration, a medication interval, and a medication schedule. The completion criteria 225 may be satisfied when the participant performs the course of electronic medication each medication interval for the medication duration. In addition, the completion criteria 225 may be satisfied when the participant performs the course of electronic medication for the medication duration according to the medication schedule.

In one embodiment, the objective 205 is maintaining a quiet space. The completion criteria 225 may be a beacon condition 235 for a quiet space such as a dining room. The reward 215 may be locking the electronic device 110 when the electronic device is within the quiet space. Thus the electronic device 110 may be locked each time the electronic device 110 is carried within the quiet space.

In one embodiment, the objective 205 is a communication objective. The communication criteria 225 may be satisfied in response to establishing communication between at least two participants. The communication criteria 225 may be measured by the electronic devices 225 of the at least two participants communicating. The reward policy 220 may be satisfied in response to the at least two participants communicating.

In one embodiment, the objective 205 is a competition objective 205. The completion criteria 225 may specify the competition. At least one participant may be designated a winner. In addition, at least one participant may be designated a loser. In one embodiment, the completion criteria 225 include a competition metric. At least one participant that best completes the competition objective 205 may be designated the winner and at least one participant that worse completes the competition objective 205 may be designated the loser based on the competition metric.

In one embodiment, the reward 215 may comprise one or more of the winner setting a lock on a application of the loser, the loser making a payment to the winner, the releasing the reward to the winner before releasing the reward to the loser. The reward 215 may be one or more of the winner setting a lock on a application of the loser, the loser making a payment to the winner, the releasing the reward to the winner before releasing the reward to the loser.

In one embodiment, the objective 205 is a movement objective. The objective criteria 225 may be satisfied in response to detecting the electronic device being carried while running, biking, traveling to a designated location, or the like. The reward policy 220 may be satisfied during the movement.

In one embodiment, the objective 205 may be accumulated. For example, the completion criteria 225 may specify a number of repetitions. The repetitions may be accumulated by the completion status 210 over a completion time interval. The reward policy 220 may be satisfied when the accumulated repetitions exceed the completion criteria 225.

In one embodiment, the reward 215 may be withdrawn when the reward policy 220 is not satisfied. For example, the reward 215 may be access to a game on the electronic device 110. The reward policy 220 may specify the participant satisfy completion criteria 225 of maintaining a specified savings account balance. The reward 215 of the game may only be provided while the reward policy 220 is satisfied. When the reward policy 220 is not satisfied, the reward 215, such as access to the game, may be withdrawn.

In one embodiment, the objective 205, completion criteria 225, reward 215, and reward policy 220 may be established by a third party. For example, a spouse may establish the objective 205 of painting a nursery with the reward 215 of unlocking a video game. The reward policy 220 may be satisfied on completion of the painting with the completion criteria 225 of validation by the spouse.

FIG. 2B is a schematic block diagram illustrating one embodiment of educational objective completion criteria 225b. The completion criteria 225b maybe organizes a data structure in a memory. In the depicted embodiment, the completion criteria 225b includes a question completion 302, question score 304, a word count 306, and a completion target 308.

The question completion 302 may specify a number of questions that are completed. For example, a participant may be required to answer a question completion 302 of 20 questions.

The question score 304 may specify a score derived from answering questions. For example, the participant may receive points for each correct answer. The some of the points may be the question score 304.

The word count 306 may specify a number of words may specify a number of words that the participant reads. Alternatively, the word count 306 may specify a number of words that the participant writes.

The completion target 308 may specify one or more tasks that must be completed by the participant. For example, the completion target 308 may be completing a test. The question completion 312, question score 304, word count 306, and/or completion target 308 may be received from an application such as a study application.

FIG. 2C is a schematic block diagram illustrating one embodiment of breathing objective completion criteria 225b. The completion criteria 225b may be organized as a data structure in a memory. In the depicted embodiment, the completion criteria 225b include a target number of breaths 310, a target breezing time 312, and a target breezing profile 314.

The target number of breaths 310 may specify a number of breaths that conform to the target breezing profile 314. The target breathing time 312 may specify a time interval of breathing that conforms to the target breezing profile 314.

The target breezing profile 314 may specify a duration of a breath, a depth of the breath, a volume of the breath, a chest movement during a breath, or the like. The target number of breast 310 and the target breathing time 312 may be measured by an electronic device 110. For example, a microphone of an electronic device 110 may detect breaths and determine a number of breaths and a breathing time. Alternatively, an accelerometer of the electronic device 110 may determine the number of breaths in the breathing time.

FIG. 2D is a schematic block diagram illustrating one embodiment of movement objective completion criteria 225c. The completion criteria 225c may be organized as a data structure in a memory. In the depicted embodiment, the completion criteria 225c includes a target movement type 320, a target movement time 322, a target movement profile 324, a target movement intensity 326, and a target movement distance 328.

The target movement type 320 may specify a type of movement such as walking, running, climbing, swimming, biking, and the like. In one embodiment, the target movement type 320 specifies one or more types of movement.

The target movement time 322 may specify a time interval for which the movement is performed by a participant to satisfy the completion criteria 225c. The target movement distance 328 may specify a distance for which the movement is performed by the participant to satisfy the completion criteria 225c.

The target movement profile 324 may specify one or more of a movement pace, a movement speed, and elevation gain, and the like. In one embodiment, the movement must comply with the target movement profile 324 for the movement to satisfy the completion criteria 225c. The target movement intensity 326 may specify one or more of a heart rate, a breathing rate, and a capillary oxygenation. In a certain embodiment, the movement must comply with the target movement intensity 326 for the movement to satisfy the completion criteria 225c.

FIG. 2E is a schematic block diagram illustrating one embodiment of location objective completion criteria 225d. The completion criteria 225d may be organized as a data structure in a memory. In the depicted embodiment, the completion criteria 225d include a target location 330 and a target time interval 332.

The target location 330 may specify a physical location. In one embodiment, the physical location is defined by three or more boundaries. Each boundary may be defined by two spatial coordinates such as GPS coordinates. Alternatively, the physical location may be defined by a center point and a radius. The center point may be a spatial coordinate and the radius may be a distance such as 30 meters.

The target time interval 332 may include a start time and an end time. The target time interval 332 may specify when a participant should be at the physical location defined by the target location 330.

FIG. 2F is a schematic block diagram illustrating one embodiment of medication objective completion criteria 225e. The completion criteria 225e maybe organizes a data structure in a memory. The completion criteria 225e may specify how an electronic device 110 is to be used for electronic medication. For example, the completion criteria 225e may specify when a participant has successfully completed a course of electronic medication. In the depicted embodiment, the completion criteria 225e include a medication duration 350, a medication interval 352, and a medication schedule 354.

The medication duration 350 may specify a time interval over which the participant should perform a course of electronic medication. For example, the medication duration 350 may specify a 30 minute course of electronic medication.

The medication interval 352 may specify a time interval between courses of electronic medication. For example, the medication interval 352 may specify performing a second course of electronic medication after 4 hour time interval from a first course of electronic medication.

The medication schedule 354 may specify a number of times in a time interval that the participant should perform the course of electronic medication for the medication duration 350 every medication interval 352. For example, the medication schedule 354 may specify that the participant should perform the course of electronic medication for the medication duration 350 five times a week.

FIG. 2G is a schematic block diagram illustrating one embodiment of a participant database 230. The participant database 230 may be organized as a data structure in a memory. The participant database 230 may include participant data 240 for each of one or more participants.

FIG. 2H is a schematic block diagram illustrating one embodiment of participant data 240. In the depicted embodiment, the participant data 240 includes a participant identifier 340, a participant address 342, a participant completion status 344, and a participant reward status 346.

The participant identifier 340 may uniquely identify a participant. The participant identifier 340 may include a name, identification number, an alias, or combinations thereof. The participant address 342 may include an address of the electronic device 110 associated with the participant, a participant telephone number, and/or other contact information.

The participant completion status 344 may specify whether the participant has satisfied the completion criteria 255 associated with the objective 205. The participant reward status 346 may indicate whether the participant has satisfied the reward policy 220.

Both the participant completion status 344 and the participant reward status 346 may be needed to determine whether to release the reward 215 to the participant. For example, a first participant may not satisfy the completion criteria 255, but if other participants do satisfy the completion criteria 255, the first participant may still satisfy the reward policy 220. Alternatively, the first participant may satisfy the completion criteria 255, but may not satisfy the reward policy 220 because other participants have not satisfied the completion criteria 255. As a result, in some embodiments, both the participant completion status 344 and the participant reward status 346 must be defined in order to determine whether to release the reward 215.

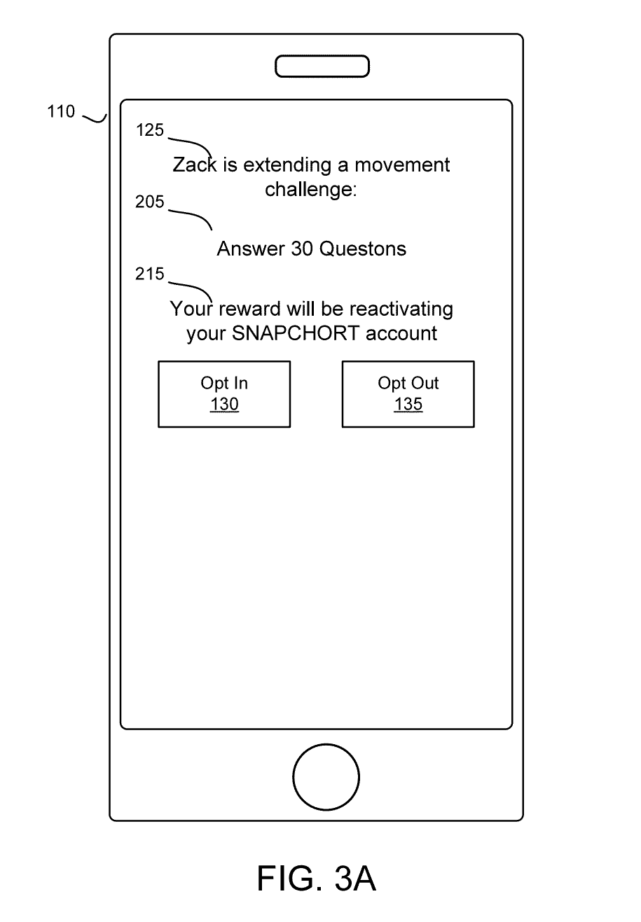

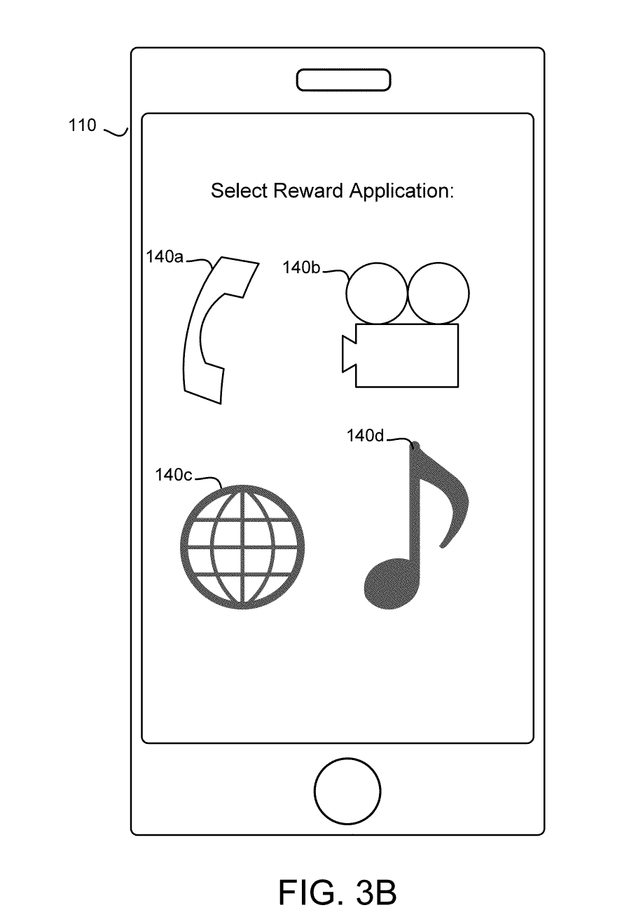

FIG. 3A is a drawing illustrating one embodiment of receiving an objective 205 and reward 215. In the depicted embodiment, an electronic device 110 has received a challenge 125 from another electronic device 110. The challenge 125 includes an objective 205 and a reward 215. A participant may have the option to opt in to the challenge 125 by selecting an opt in control 130. Alternatively, the participant may opt out of the challenge by selecting an opt out button 135.

FIG. 3B is a drawing illustrating one embodiment of selecting an application. In the depicted embodiment, the electronic device 110 displays icons 140 for a plurality of applications. A participant is asked to of the application that will be used as a reward.

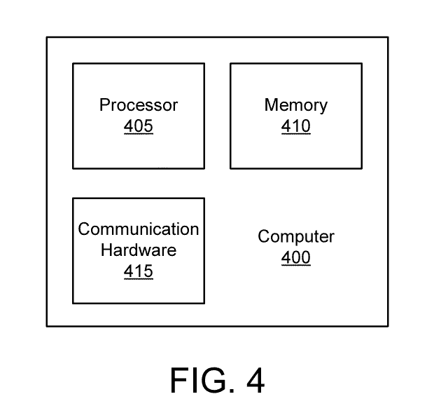

FIG. 4 is a schematic block diagram illustrating one embodiment of a computer 400. The computer 400 may be embodied in an electronic device 110, a server 105, and/or a data source 120. In the depicted embodiment, the computer 400 includes a processor 405, a memory 410, and communication hardware 415. The memory 410 may be a semiconductor storage device, a hard disk drive, an optical storage device, a micromechanical storage device, or combinations thereof. The memory 410 may store code. The processor 405 may execute the code. The communication hardware 415 may communicate with other devices.

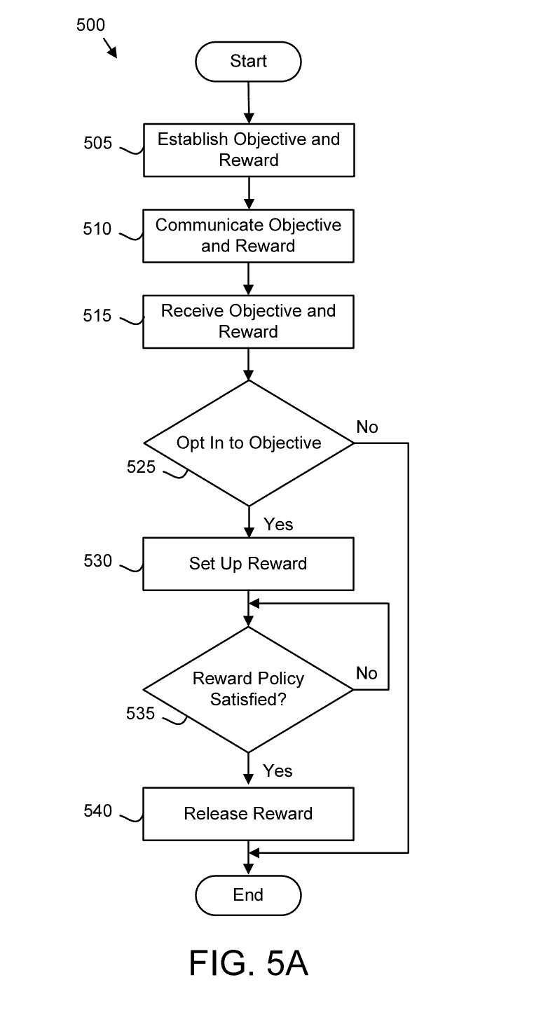

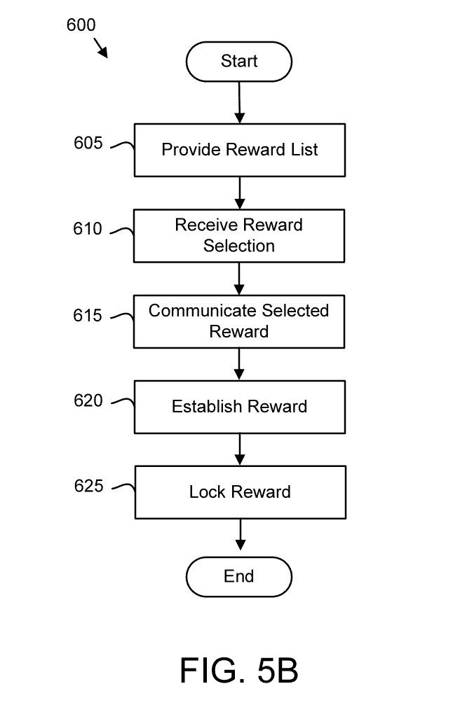

FIG. 5A is a schematic flow chart diagram illustrating one embodiment of a reward management method 500. The method 500 may manage rewards 215 for one or more participants through the electronic devices 110 of the participants. The method 500 may be performed by a processor 405. Alternatively, the method 500 may be performed by computer readable storage medium such as the memory 410. The computer readable storage medium may store code that is executed by the processor 405 to perform the method 500.

The method 500 starts, and in one embodiment, a participant establishes the objective 205 and the reward 215 using the processor 405 of a second electronic device 110b. In addition, the processor 405 may be used to define the completion criteria 225, define the reward policy 220, and identify the participants in the participant database 230.

In one embodiment, the participant enters the objective 205. The participant may select a type of the objective 205 and be prompted to enter completion criteria 225 based on the type of the objective 205. The participant may further be prompted to select a reward type for the reward 215. The participant may select the reward type. In addition, the participant may be prompted to select a reward of the reward type. Alternatively, a specific reward 215 may be selected later by another participant as will be described for step 530 and in FIG. 5B.

The processor 405 may communicate 510 the objective 205 and/or reward 215. The objective 205 and/or reward 215 may be communicated 505 from a second electronic device 110b of a second participant to the first electronic devices 110a of the one or more first participants. Alternatively, the objective 205 and/or reward 215 may be publicly posted such as a social media site, a website, or the like.

In one embodiment, the processor 405 of each first electronic device 110a determines 525 if the first participant opts in to the objective 205. The first participant may select the opt in button 130 to opt in and select the opt out button 135 to opt out. If the processor 405 determines 525 that the first participant opts out, the method 500 ends. In one embodiment, the processor 405 determines 525 whether the first participant opts in to the objective 205 each time the second electronic device 110b communicates the objective 205 2 the first electronic device 110a. Alternatively, if the first participant opts in once to an objective 205, the processor 405 will automatically determine 525 that the first participant opts in each time the first electronic device 110a receives an objective 205.

If the processor 405 determines 525 that the first participant opts in, the processor 405 sets up 530 the reward 215. In one embodiment, the first participant selects the reward 215 using the processor 405 of the first electronic device 110. In addition, the first electronic device 110 may communicate the selected reward 215 to the second processor 110b. The set up 530 of the reward 215 is described in more detail in FIG. 5B.

The processor 405 may determine 535 if the reward policy 220 is satisfied for the first participant. One or more electronic devices 110 and/or the server 105 may further receive the completion status 210 and/or the participant completion statuses 344 for the objective 205. The completion status 210 may be received 520 from the electronic devices 110 of the one or more participants. Alternatively, the completion status 210 and/or the participant completion statuses 344 may be received from the data source 120. In one embodiment, a third-party party is interrogated for the completion status 210. For example, an email message may be sent to the third-party asking for validation.

The first participant may satisfy the reward policy 220 by satisfying the completion criteria 225. However, because the completion criteria 225 may also include a criterion for the participant completion status 344 of other participants, the processor 405 must look beyond the participant completion status 344 of the first participant. For example, if the completion criteria 225 specifies that all participants must satisfy the completion criteria 225, then the first participant may satisfy the completion criteria 225 but not satisfy the reward policy 220 if some other participants have not satisfy the completion criteria 225.

Alternatively, if the completion criteria 225 specify that only one participant must satisfy the completion criteria 225, than the first participant may satisfy the reward policy 220 without satisfying the completion criteria 225 if another participant has satisfy the completion criteria 225.

The completion criteria 225 may be accumulated over time and may subsequently satisfy the reward policy 220. For example, the completion criteria 225 may be satisfied when the participant walks a kilometer. In this example, the completion criteria are satisfied after the participant walks the kilometer.

Alternatively, the completion criteria 225 may be measured over a current time interval such as one to ten minutes. The reward is only provided while the completion criteria 225 are being satisfied. For example, the completion criteria 225 may be to walk within a ten minute time interval. The completion criteria 225 may only be satisfied if the participant has walked with in the most recent ten minute time interval.

If the processor 405 determines 535 of the reward policy 220 is not satisfied, the processor continues to determine 535 when the reward policy 220 is satisfied. If the reward policy 220 is satisfied, the processor 405 may release the reward 215 and the method 500 ends. The reward 215 may be released 540 by releasing of lock on an application selected by a participant. Alternatively, the reward 215 may be released 540 by releasing a physical lock, removing a pop up, distributing a monetary payment, and/or releasing a block on a URL.

An electronic device 110 may release 525 the reward 215 in response to the reward policy 220 being satisfied and the method 500 ends. In one embodiment, a first electronic device 110 releases 525 the reward 215 to a first participant if the first participant satisfies the reward policy 220. Alternatively, each electronic device 110 may release 525 the reward 215 to all participants if at least one participant satisfies the reward policy 220. In a certain embodiment, the electronic devices 110 only release 525 the reward 215 if all participants satisfy the reward policy 220.

FIG. 5B is a schematic flow chart diagram illustrating one embodiment of a reward set up method 600. The method 600 may be performed by a processor 405. Alternatively, the method 600 may be performed by computer readable storage medium such as the memory 410. The computer readable storage medium may store code that is executed by the processor 405 to perform the method 600.

The method 600 starts, and in one embodiment, the processor 405 provides 605 a reward list of rewards 215. The rewards 215 of the reward list may initially be generated by the second participant using the second electronic device 110b. In one embodiment, the rewards 215 are applications for which access will be restored. The reward list may show the icons 140 for the applications as shown in FIG. 3B.

The processor 405 may receive 610 a reward selection of a reward 215. In one embodiment, the processor 405 receives a selection of an icon 140 indicating that access to the corresponding application will be blocked until the first participant satisfies both the completion criteria 225 and the reward policy 220.

The processor 405 may communicate 615 the selected reward 215 to the second electronic device 110b. Alternatively, the selected reward 215 may be communicated to the server 105. The processor 405 may further establish 620 the reward 215 by generating and recording the reward data 200.

In one embodiment, the processor 405 calculates the reward policy 220 based on the completion criteria 225 selected by the second participant. The reward policy 220 may distinguish one satisfaction of the completion criteria 225 also results in satisfaction of the reward policy 220.

In one embodiment, the reward 215 may be established 520 in response to a message from the electronic device 510 of each participant. In one embodiment, one or more electronic devices 510 contribute a selected reward 215. In addition, the electronic devices 510 may establish 515 one reward 215 from the selected rewards 215 through a ballot.

Alternatively, each electronic device 110 may establish 515 the reward 215 for the participant associated with the electronic device 110. Thus, each participant may establish 515 his own reward 215. In a certain embodiment, the electronic device 110 of a first participant may establish 515 the reward 215 for a second participant.

In one embodiment, the processor 405 locks 625 the reward 215. For example, the selected application may be locked to prevent access to the selected application on the first electronic device 110a. Alternatively, a physical lock may be set. In addition, a pop up may be added to a display of the first electronic device 110a. In a certain embodiment, a block is added to the URL.

The embodiments allow the second participant to communicate the objective 205 and the reward 215 from the second electronic device 110b to the first participant at the first electronic device 110a. The first electronic device 110a may set up the reward 215 including blocking access to a selected application until the first participant satisfies the completion criteria 225 of the objective 205 and satisfies the reward policy 220. Thus the first participant may be locked from using the reward 215 such as the application. When the first participant satisfies the reward policy 220 the reward 215 is released. Thus the first participant may again have access to the reward application.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, by use of a processor, an objective and a reward from a second electronic device;
receiving a completion status for the objective at a first electronic device; and
releasing the reward in response to a reward policy being satisfied.

2. The method of claim 1, wherein the reward is releasing a lock on a first application of the first electronic device and the second electronic device sets the lock in response a second participant selecting the first application from an application list for a first participant.

3. The method of claim 1, wherein the objective is an educational objective comprising completion criteria of one or more of a question completion, a question score, a word count, and a completion target.

4. The method of claim 1, wherein the objective is a breathing objective comprising completion criteria of a target number of breaths and a target breathing time in compliance with a target breathing profile.

5. The method of claim 1, wherein the objective is a movement objective comprising completion criteria of a target movement type, a target movement time, and a target movement profile, and the reward policy is satisfied during movement.

6. The method of claim 1, the method further comprising communicating the objective to one or more participants.

7. The method of claim 1, wherein the objective is publically posted.

8. The method of claim 1, the method further comprising determining whether a participant opts in to the objective.

9. The method of claim 1, the method further comprising establishing the reward in response to a communication of a reward selection from each participant.

10. The method of claim 1, wherein the reward is selected from the group consisting of releasing a lock, releasing a lock on a first application, removing a pop-up, distributing a monetary payment, and releasing a block on a Universal Resource Locator (URL).

11. The method of claim 1, wherein the reward policy is satisfied if all participants complete the objective and the reward is released to all participants.

12. The method of claim 1, wherein the objective is a combined objective and the reward policy is satisfied if one or more participants complete the combined objective.

13. The method of claim 11, wherein the reward policy is satisfied if at least one participant completes the combined objective, and wherein the reward is released to the at least one participant completing the combined objective.

14. The method of claim 11, wherein the reward policy is satisfied if at least one participant completes the combined objective, and wherein the reward is released to all participants.

15. The method of claim 1, wherein the reward policy is satisfied when a first participant completes the objective, and wherein the reward is released to the first participant.

16. The method of claim 1, wherein the objective is a location objective and the reward policy is satisfied when all participants check in at the location objective and the participants check in using one or more of a wireless communication position and a global positioning system coordinate.

17. A program product comprising a non-tangible computer readable storage medium storing code that is executed by a processor to perform:
receiving an objective and a reward from a second electronic device;
receiving a completion status for the objective at a first electronic device; and
releasing the reward in response to a reward policy being satisfied.

18. The program product of claim 17, wherein the reward is releasing a lock on a first application of the first electronic device and the second electronic device sets the lock in response a second participant selecting the first application from an application list for a first participant.

19. An apparatus comprising:
a memory storing code;
a processor that executes the code to perform:
receiving an objective and a reward from a second electronic device;
receiving a completion status for the objective at a first electronic device; and
releasing the reward in response to a reward policy being satisfied.

20. The apparatus of claim 19, wherein the reward is releasing a lock on a first application of the first electronic device and the second electronic device sets the lock in response a second participant selecting the first application from an application list for a first participant.
